(19) United States
(12) Patent Application Publication
(10) Pub. No.: US 2025/0237774 A1
(43) Pub. Date: Jul. 24, 2025

(54) LOW-FREQUENCY HYDRAULIC MARINE CONTROLLABLE SEISMIC SOURCE SYSTEM

(71) Applicant: Jilin University, Changchun (CN)

(72) Inventors: Xingguo HUANG, Changchun (CN); Wenqing SHANG, Changchun (CN); Guanqiao CHEN, Changchun (CN)

(73) Assignee: Jilin University, Changchun (CN)

(21) Appl. No.: 18/640,425

(22) Filed: Apr. 19, 2024

(30) Foreign Application Priority Data
Jan. 23, 2024 (CN) 202410090056.4

(51) Int. Cl. G01V 1/135; G01V 1/38

(52) U.S. Cl. CPC G01V 1/135; G01V 1/3835; G01V 2210/1214; G01V 2210/1293

(57) ABSTRACT

A low-frequency hydraulic marine controllable seismic source system includes a signal excitation system, a hydraulic servo system, and a marine vibration excitation system. An electrohydraulic servo valve is communicated with an oil way. A signal end is connected to each of the signal excitation system, a vibration exciter of the marine vibration excitation system, and a displacement sensor, an acceleration sensor, and an attitude sensor arranged on the vibration exciter of the marine vibration excitation system. After receiving an excitation sweep signal, the electrohydraulic servo valve controls an internal valve core of the electrohydraulic servo valve to generate a displacement to move continuously. A force of equal magnitude indicated by an input/output signal of a feedback rod is applied to the vibration exciter to perform a vibration in a horizontal direction and radiates to seawater to generate a low-frequency high-energy seismic wave.

### CROSS-REFERENCE TO RELATED APPLICATIONS

This application claims priority to Chinese Patent Application No. 202410090056.4, filed on Jan. 23, 2024, which is incorporated herein by reference in its entirety.

### TECHNICAL FIELD

The present application belongs to the technical field of seismic source generators, and in particular, to a low-frequency hydraulic marine controllable seismic source system.

### BACKGROUND

Exploration of marine resources is a necessary and inevitable trend. Seismic exploration is one of the basic methods for geophysical exploration, which is widely used in energy exploration and geological exploration due to high detection accuracy thereof.

In recent years, collecting low-frequency seismic data by using a controllable seismic source technology has attracted the attention of people. Different from a traditional explosive seismic source, a controllable seismic source controls a vibration exciter to vibrate continuously for a long time according to an artificially set scanning signal to generate a seismic wave. Therefore, the controllable seismic source is more suitable for marine resource exploration due to excellent environmental protection thereof.

In an exploration process, a low-frequency signal attenuates slowly in propagation and has strong penetrating capacity. Meanwhile, a low-frequency is important to improve the accuracy of seismic inversion in an acoustic wave impedance process and implement velocity model determination or full waveform inversion, and can be used for obtaining structural information of a deep reservoir.

However, for a traditional seismic vibrator, it is generally difficult to apply sufficient force to a target surface at a frequency lower than 5 Hz, especially from 1 to 3 Hz, due to mechanical and hydraulic limitations in a system of the traditional seismic vibrator. So, it is commonly seen that a scanning signal is designed to start from 5 Hz in most controllable seismic source data collection. The lack of low-frequency information has a non-negligible impact on seismic inversion. Therefore, it is necessary to invent a low-frequency high-power marine controllable seismic source.

### SUMMARY

For technical problems mentioned above, the present application provides a low-frequency hydraulic marine controllable seismic source system, which has the advantages that an excitation sweep signal can be achieved, and a vibration with an output force of 20 kN and a total stroke displacement up to 300 millimeters can be implemented at 2 to 100 Hz underwater. A sound source level of excitation energy can reach 190 dB.

The objective of the present application is achieved by the following technical solutions.

A low-frequency hydraulic marine controllable seismic source system includes a signal excitation system, a hydraulic servo system, and a marine vibration excitation system.

Both the signal excitation system and the hydraulic servo system are arranged on a ship. The marine vibration excitation system is placed in seawater.

The hydraulic servo system includes an electrohydraulic servo valve. An oil port of the electrohydraulic servo valve is communicated with an oil way. The marine vibration excitation system includes a vibration exciter, a displacement sensor, an acceleration sensor, and an attitude sensor. A signal end of the electrohydraulic servo valve is connected to the signal excitation system. The signal end of the electrohydraulic servo valve is also connected to the displacement sensor, the acceleration sensor, and the attitude sensor.

The signal excitation system generates an excitation sweep signal, and transmits the excitation sweep signal to the electrohydraulic servo valve. After receiving the excitation sweep signal, the electrohydraulic servo valve controls an internal valve core of the electrohydraulic servo valve to generate a displacement to move continuously. After the electrohydraulic servo valve receives an input/output signal of a feedback rod, the feedback rod of the electrohydraulic servo valve outputs and applies a force of equal magnitude indicated by the input/output signal of the feedback rod to the vibration exciter to enable the vibration exciter to perform a vibration in a horizontal direction, and the force radiates to the seawater to generate a low-frequency high-energy seismic wave. The displacement sensor, the acceleration sensor, and the attitude sensor mounted in the marine vibration excitation system monitor a vibration state in real time, and feed information back to the electrohydraulic servo valve to control a vibration frequency and an amplitude.

Preferably, the hydraulic servo system includes an oil tank, an oil outlet pipeline, and an oil return pipeline. The oil outlet pipeline includes an oil suction filter, a plunger pump, a one-way valve, a high pressure filter, a high pressure accumulator, and an electromagnetic overflow valve. One end of the oil suction filter is connected to the oil tank, and the other end is connected to the high pressure filter through the plunger pump and the one-way valve. One end of the high pressure accumulator is connected to the high pressure filter, and the other end is connected to an oil outlet P; and the high pressure accumulator is arranged to absorb a high frequency pulsation component at an outlet of the plunger pump to maintain a stable oil pressure. One end of the electromagnetic overflow valve is connected to the oil tank, and the other end is connected to an oil way between the high pressure filter and the high pressure accumulator. The oil way is also connected to a seismic resistant pressure gauge through a pressure measuring joint and hose. The oil return pipeline includes an overflow valve, a low pressure accumulator, and an oil return filter. One end of the oil return pipeline is connected to the oil tank, and the other end is connected to an oil return port T through the overflow valve. An oil way between the overflow valve and the oil return port T is also connected to the low pressure accumulator to absorb an oil pressure of the oil return pipeline and eliminate oil discharge pressure fluctuations. The low pressure accumulator is also connected to a pressure gauge.

Preferably, there is a flexible connection between the filter and the plunger pump; and a manual ball valve is arranged on a pipeline between the filter and the flexible connection.

Preferably, an oil cooler is arranged on one side outside the oil tank to cool hydraulic oil. An air filter is mounted above a side, close to the oil cooler, in the oil tank to filter air circulating in the oil tank. A liquid level gauge is also mounted on a side surface in the oil tank. A metallic thermometer is also arranged on an inner wall of the oil tank to detect a temperature of the hydraulic oil.

Preferably, the marine vibration excitation system includes a housing, a vibration exciter, support discs, and conical flange covers. The housing is a cylindrical stainless steel housing. The vibration exciter is coaxially arranged in the housing through a fixing plate. The vibration exciter is a cylinder fixed double-rod piston vibration exciter. The support discs are arranged at two ends of the housing. Two ends of an outer cylinder of the vibration exciter are respectively connected to the support discs. Piston rods at two ends extend out of the support discs and are connected to the conical flange covers arranged on outer sides of the support discs. A rubber buffer ring is arranged between the housing and the conical flange cover. A top of the housing is provided with lifting lug seats, is provided with an oil inlet, an oil outlet, an air hole, and a wire hole, and is connected to the electrohydraulic servo valve through the oil inlet and the oil outlet. A data line is connected to the vibration exciter and the electrohydraulic servo valve through the wire hole. Lifting lugs are arranged at tops of the two conical flange covers. A plurality of observation windows are formed in the housing on two sides of the lifting lug seat. A counterweight box is arranged at a bottom of the housing. The vibration exciter is connected to the hydraulic servo system through the oil inlet, the oil outlet, and the wire hole in the housing. The air hole is externally connected to an air pump to realize underwater static pressure compensation.

Preferably, the vibration exciter is the cylinder fixed double-rod piston vibration exciter. The fixing plate is a connecting plate with a circular hole in the center. The circular hole of the fixing plate matches a piston rod of the vibration exciter. The vibration exciter penetrates through the circular hole of the fixing plate. Two ends of the fixing plate are connected to the housing.

Preferably, a center hole that matches the piston rod of the vibration exciter is formed in a center of the support disc. Bolt holes that match a connecting flange on the outer cylinder of the vibration exciter are formed along a periphery of the center hole. A plurality of through holes are formed in a circumferential direction of the support disc to ensure a consistent working air pressure inside a cavity of the stainless steel housing.

Preferably, a center of the conical flange cover is connected to the piston rod at each of the two ends of the vibration exciter; and an edge of the conical flange cover is connected to the housing through the buffer ring.

Preferably, the displacement sensor of the marine vibration excitation system is mounted at a tail end of the piston rod of the vibration exciter; and the acceleration sensor and the attitude sensor are respectively mounted on inner sides of the conical flange covers at the two ends of the vibration exciter.

Preferably, a maximum vibration stroke of the vibration exciter is 300 millimeters.

The present application has the following beneficial effects.
1. According to the present application, a signal generation system generates a target scanning signal, and a signal excitation system inputs the signal to an electrohydraulic servo valve. After receiving an excitation sweep signal, the electrohydraulic servo valve controls an internal valve core of the electrohydraulic servo valve to generate a displacement to move continuously to convert a liquid oil pressure difference into kinetic energy, and performs a high-energy vibration at a low frequency according to the scanning signal; and the vibration radiates to seawater to generate a low-frequency high-energy seismic wave. A displacement sensor mounted on a vibration exciter and an acceleration sensor and an attitude sensor mounted on inner sides of conical flange covers monitor a vibration state in real time, and feed information back to the electrohydraulic servo valve to control a vibration frequency and an amplitude. The vibration exciter may be set according to the sweep signal to accurately achieve a sustained vibration as low as 2 Hz, and can change movement of the valve core of the electrohydraulic servo valve through the signal excitation system, thereby changing a vibration velocity of the vibration exciter.
2. According to the present application, an underwater high-energy controllable seismic source is driven by using a hydraulic pressure. A bottleneck of a small vibration stroke of a conventional hydraulic controllable seismic source is broken through. The present application can achieve a high-energy vibration with a force output of 20 kN at 2 to 100 Hz, so as to collect low-frequency vibration information to facilitate subsequent geological data processing and analysis. A total vibration stroke can reach 300 mm, and a maximum sound pressure level of the controllable seismic source within a coverage frequency band can reach 190 dB.
3. The hydraulic servo system of the present application is used, a high pressure oil outlet pipeline and a back-pressure pipeline are arranged, and a high pressure accumulator and a low pressure accumulator are separately arranged to suppress fluctuations in a supply pressure. An electromagnetic overflow valve that maintains a normally closed state is arranged on the high pressure oil outlet pipeline. If any abnormality is detected by the seismic resistant pressure gauge, the electromagnetic overflow valve is opened, so that excess flow overflows back into the oil tank to ensure a pressure at an inlet of the electromagnetic overflow valve.
4. According to the present application, an air hole is formed in a surface of a stainless steel housing, which can be used for underwater static pressure compensation. A marine vibration excitation system can work normally at 5 to 30 meters underwater.
5. According to the marine vibration excitation system of the present application, the vibration exciter is arranged in the housing, piston rods at two ends of the vibration exciter are connected to the conical flange covers, the piston rods of the vibration exciter drive the conical flange covers to vibrate when moving horizontally, and a vibration radiates to seawater to generate a low-frequency high-energy seismic wave. The displacement sensor, the acceleration sensor, and the attitude sensor are assembled on the vibration exciter, which can monitor a working state of the vibration exciter in real time, and feed the working state back to the electrohydraulic servo valve to modify and control a displacement of a valve core to realize closed-loop control. If an attitude abnormality occurs, warning and reminding can be implemented.
6. According to the present application, great loss in transmission of vibration energy caused by water resistance when ordinary flat flange covers vibrate underwater is overcome. When the conical flange covers push water to vibrate, fluid resistance is lower due to conical structures of the conical flange covers. Therefore, the loss of the vibration energy provided by the vibration exciter and the vibration energy generated by pushing the water by the conical flange covers is lower during an underwater vibration.
7. The hydraulic servo system of the present application is assembled on a ship for working. A work structure of an underwater marine vibration excitation system is compact, and a power-to-weight ratio is low, which facilitates replacing test areas.

### BRIEF DESCRIPTION OF THE DRAWINGS

FIG. 1 is a schematic flowchart of an embodiment of the present application.

FIG. 2 is a schematic diagram of an oil way of a hydraulic servo system according to an embodiment of the present application.

FIG. 3 is a top view of a three-dimensional model of a marine vibration excitation system according to an embodiment of the present application.

FIG. 4 is a front view of a three-dimensional model of a marine vibration excitation system according to an embodiment of the present application.

FIG. 5 is a side view of a housing of a marine vibration excitation system according to an embodiment of the present application.

FIG. 6 is an inside view of a marine vibration excitation system according to an embodiment of the present application.

FIG. 7 is a side view of a marine vibration excitation system according to an embodiment of the present application.

FIG. 8 is a schematic diagram of a vibration exciter according to an embodiment of the present application.

FIG. 9 is a working flowchart of a control system according to an embodiment of the present application.

FIG. 10 is a control method of the system according to an embodiment of the present application.

### DETAILED DESCRIPTION OF THE EMBODIMENTS

The present application is described in detail below in combination with the accompanying drawings and embodiments.

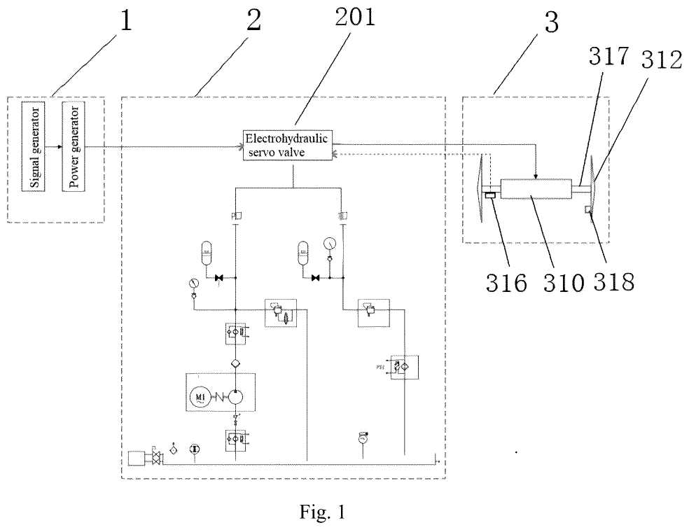

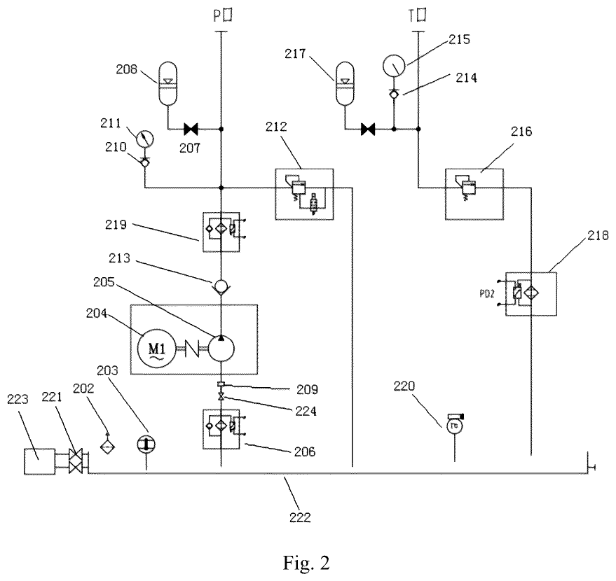

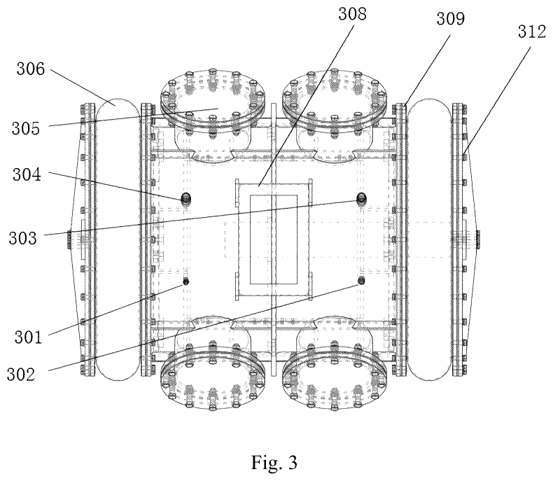

As shown in FIG. 1, a low-frequency hydraulic marine controllable seismic source system of the present application includes a signal excitation system 1, a hydraulic servo system 2, and a marine vibration excitation system 3. The signal excitation system 1 is arranged on a ship. An oil port of an electrohydraulic servo valve 201 of the hydraulic servo system 2 is communicated with an oil way. A signal end of the electrohydraulic servo valve 201 is connected to the signal excitation system 1. The signal end of the electrohydraulic servo valve 201 is also connected to a displacement sensor 316, an acceleration sensor 317, and an attitude sensor 318 arranged on the marine vibration excitation system 3. The signal excitation system 1 generates an excitation sweep signal, and transmits the excitation sweep signal to the electrohydraulic servo valve 201. After receiving the excitation sweep signal, the electrohydraulic servo valve 201 controls an internal valve core of the electrohydraulic servo valve to generate a displacement to move continuously. After the electrohydraulic servo valve receives an input/output signal of a feedback rod, the feedback rod of the electrohydraulic servo valve outputs and applies a force of equal magnitude indicated by the input/output signal of the feedback rod to the vibration exciter to enable the vibration exciter to perform a vibration in a horizontal direction, and the force radiates to the seawater to generate a low-frequency high-energy seismic wave. The displacement sensor 316, the acceleration sensor 317, and the attitude sensor mounted on the marine vibration excitation system 3 monitor a vibration state in real time, and feed information back to the electrohydraulic servo valve 201 to control a vibration frequency and an amplitude.

Further, the signal excitation system 1 is arranged on the ship, and includes a signal generator and a power amplifier connected with each other. The excitation sweep signal is transmitted to the electrohydraulic servo valve 201 to control the vibration frequency and the amplitude after being amplified.

Further, the hydraulic servo system 2 includes an oil tank 222, an oil outlet pipeline, and an oil return pipeline. The oil outlet pipeline includes an oil suction filter 206, a plunger pump 205, a one-way valve 213, a high pressure filter 219, a high pressure accumulator 208, and an electromagnetic overflow valve 212. One end of the oil suction filter 206 is connected to the oil tank 222, and the other end is connected to the high pressure filter 219 through the plunger pump 205 and the one-way valve 213. One end of the high pressure accumulator 208 is connected to the high pressure filter 218, and the other end is connected to an oil outlet P; and the high pressure accumulator is arranged to absorb a high frequency pulsation component at an outlet of the plunger pump to maintain a stable oil pressure. One end of the electromagnetic overflow valve 212 is connected to the oil tank 222, and the other end is connected to an oil way between the high pressure filter 219 and the high pressure accumulator 208. The oil way is also connected to a seismic resistant pressure gauge 211 through a pressure measuring joint and hose 210. The oil return pipeline includes an overflow valve 216, a low pressure accumulator 217, and an oil return filter 218. One end of the oil return pipeline 218 is connected to the oil tank 222, and the other end is connected to an oil return port T through the overflow valve 216. An oil way between the overflow valve 216 and the oil return port Tis also connected to the low pressure accumulator 217 to absorb an oil pressure of the oil return pipeline and eliminate oil discharge pressure fluctuations. The low pressure accumulator 217 is also connected to a pressure gauge 215. A T-port pressure measuring joint and hose 214 is arranged on the pressure gauge 215.

There is a flexible connection 209 between the filter 206 and the plunger pump 205; and a ball valve 224 is arranged on a pipeline between the filter 206 and the flexible connection 209.

An oil cooler 223 is arranged on one side outside the oil tank 222 to cool hydraulic oil, and is connected to the oil tank 222 through the manual ball valve 221. An air filter 202 is mounted above a side, close to the oil cooler 223, in the oil tank 222 to filter air circulating in the oil tank 222. A liquid level gauge 203 is also mounted on an inner wall of the oil tank 222 to detect a position of the hydraulic oil. A metallic thermometer 220 is also arranged on an inner wall of the oil tank 222 to detect a temperature of the hydraulic oil in the oil tank.

In this embodiment, the volume of the oil tank 222 is 600 L. The electrohydraulic servo valve 201 is pilot operated electro-hydraulic servo valve. A starting pressure of the plunger pump 205 is 0.5 MPa. A starting pressure of the one-way valve 213 is 0.5 MPa. A range of the pressure gauge 215 is 0 to 40 MPa.

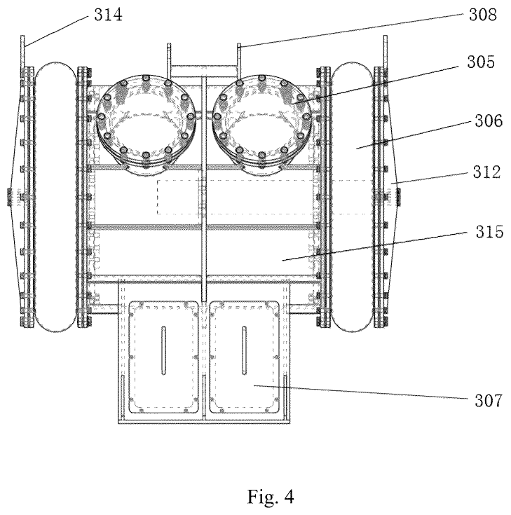

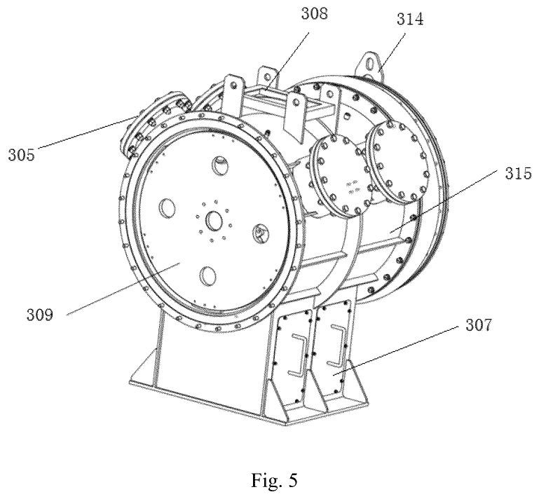

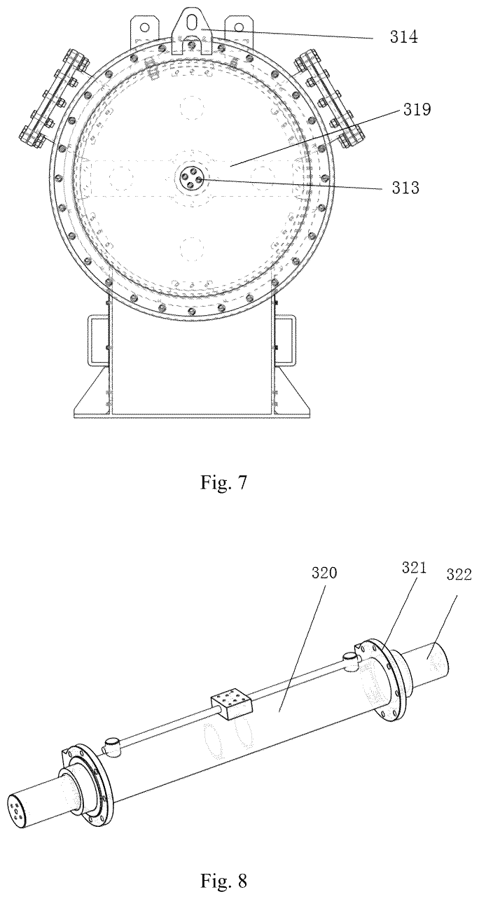

As shown in FIG. 4 to FIG. 9, the marine vibration excitation system 3 includes a housing 315, a vibration exciter 310, support discs 309, and conical flange covers 312. In this embodiment, the housing 315 is a cylindrical stainless steel housing. The vibration exciter 310 is coaxially arranged in the housing through a fixing plate 319. The vibration exciter 310 is a cylinder fixed double-rod piston vibration exciter. The support discs 309 are arranged at two ends of the housing 315. Two ends of an outer cylinder of the vibration exciter 310 are respectively connected to the support discs 309. Piston rods 322 at two ends extend out of the support discs 309 and are connected to the conical flange covers 312 arranged on outer sides of the support discs 309. A rubber buffer ring 306 is arranged between the housing 315 and the conical flange cover 312. A top of the housing 315 is provided with lifting lug seats 308, is provided with an oil inlet 304, an oil outlet 303, an air hole 301, and a wire hole 302, and is connected to the electrohydraulic servo valve 201 through the oil inlet 304 and the oil outlet 303. A data line is connected to the vibration exciter 310 and the electrohydraulic servo valve 201 through the wire hole 302. The air hole 301 is externally connected to an air pump, and is arranged to balance a working air pressure inside the stainless steel housing 315 to realize underwater static pressure compensation. Lifting lugs 314 are arranged at tops of the two conical flange covers 312. A plurality of observation windows 305 are formed in the housing 315 on two sides of the lifting lug seat 308. In this embodiment, there are four observation windows 305 in total, which are distributed on two sides of the stainless steel housing 315 in pairs and are arranged to observe a working state of the vibration exciter 310 inside, so as to facilitate maintenance work. A counterweight box is arranged at a bottom of the housing 315. The vibration exciter 310 is connected to the hydraulic servo system 2 through the oil inlet 304, the oil outlet 303, the air hole 301, and the wire hole 302 in the housing 315. Specifically, the vibration exciter 310 is connected to an oil outlet P of the hydraulic servo system 2 through the oil inlet 304, is connected to an oil return port T through the oil outlet 303, and is connected to the electrohydraulic servo valve through the wire hole 302. The air hole is externally connected to an air pump to realize underwater static pressure compensation. Specifically, the stainless steel housing 315 of the marine vibration excitation system is subjected to pressure compensation with a corresponding pressure through the air hole 301 according to an air pressure of an underwater working environment before compensating, so as to ensure that the vibration exciter can work normally under a static pressure condition of 5 to 30 meters underwater.

According to the present application, a liquid oil pressure difference is converted into kinetic energy through the hydraulic servo system, then the vibration exciter is driven to perform a low-frequency high-energy vibration according to a scanning signal, and the vibration exciter is rigidly connected to the conical flange covers and is coupled with seawater, thereby implementing the low-frequency high-energy vibration of a marine controllable seismic source.

Further, the fixing plate 319 is a connecting plate with a circular hole in the center. The circular hole of the fixing plate matches an extending end of the piston rod 322 of the vibration exciter 310. Two ends of the vibration exciter 310 penetrate through the circular holes of the fixing plates 319. Two ends of the fixing plate 319 are connected to the housing 315.

Further, as shown in FIG. 1, the marine vibration excitation system 3 further includes a displacement sensor 316, an acceleration sensor 317, and an attitude sensor 318. The displacement sensor 316 is mounted at a tail end of the piston rod 322 of the vibration exciter 310; and the acceleration sensor 317 and the attitude sensor 318 are respectively mounted on inner sides of the conical flange covers.

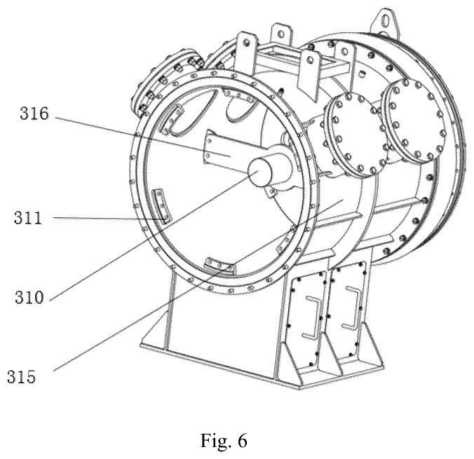

As shown in FIG. 6, a center hole that matches the vibration exciter 310 is formed in a center of the support disc 309. Bolt holes that match a connecting flange 321 on the outer cylinder 320 of the vibration exciter 310 are formed along a periphery of the center hole. In this embodiment, four circular through holes are also formed in a circumferential direction of the support disc 309, so as to ensure a consistent working air pressure inside a cavity of the stainless steel housing. The support discs 309 are arranged to support and fix the vibration exciter 310 and bear part gravity of the conical flange cover 312. The support discs are fixed to the housing 315 through support disc fixing screws 311. In this embodiment, each support disc fixing screw 311 includes six groups of screws, and each group includes three screws. The support disc fixing screw is mounted on an inner side of the stainless steel housing 315.

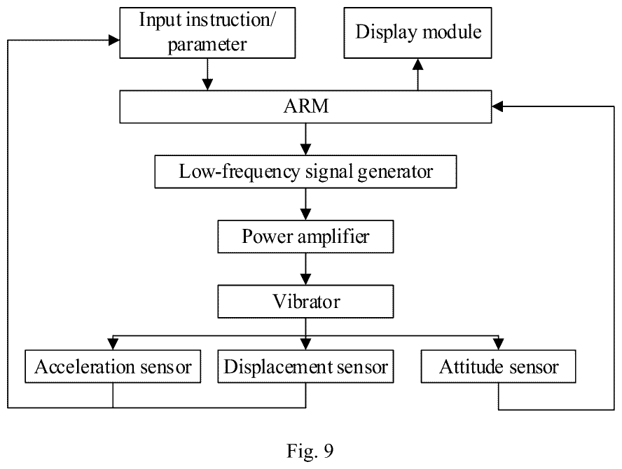

Referring to FIG. 9, in this embodiment, the piston rod of the vibration exciter 310 is rigidly connected to the conical flange cover 312 through four vibration exciter fixing screws 313. The rubber buffer ring 316 is a rubber ring. One end of the rubber ring is connected to the stainless steel housing 315, and the other end is connected to the conical flange cover 312. There two conical flange covers 312 in total. Centers of the conical flange covers 312 are rigidly connected to the piston rods at two ends of the vibration exciter 310. An edge of the conical flange cover is connected to the rubber buffer ring 306. There are two lifting lugs 314 in total, which are respectively welded on upper sides of the two conical flange covers 312 and are arranged for lifting work during assembling.

In this embodiment, the vibration exciter 310, and various sensors used in the signal excitation system 1 and the hydraulic servo system 2 are all existing purchased components.

A working process of the low-frequency hydraulic marine controllable seismic source system of the present application is as follows.

First, a sweep signal is set through a signal generator, and is input to an electrohydraulic servo valve 201 after passing through a signal amplifier. The electrohydraulic servo valve 201 receives the sweep signal to activate a motor 204 of a plunger pump 205 to start to rotate to drive the plunger pump 205 to start to absorb oil. Hydraulic oil is pumped into a high pressure hose after impurities are filtered by an oil suction filter 206, and enters an oil supply port P through a high pressure filter 219 and a one-way valve 213. In this process, an electromagnetic overflow valve 212 is maintained in a normally closed state. If any abnormality is detected by a seismic resistant pressure gauge 211, the electromagnetic overflow valve 212 is opened at this moment, so that excess flow overflows back into an oil tank 222 to ensure a pressure at an inlet of the electromagnetic overflow valve 212. High pressure hydraulic oil enters the electrohydraulic servo valve 201 through the port P, flows out of the electrohydraulic servo valve 201 through a port T, and flows back to the oil tank 222 through an overflow valve 216 and an oil return filter 218. An oil return filter 208 and a low pressure accumulator 217 are respectively placed on a high pressure side and a back-pressure side to suppress fluctuations in a supply pressure.

After receiving an excitation sweep signal, the electrohydraulic servo valve 201 controls an internal valve core of the electrohydraulic servo valve to generate a displacement to move continuously. A force of equal magnitude indicated by an input/output signal of a feedback rod of the electrohydraulic servo valve is applied to a piston rod of the vibration exciter 310, the piston rod is rigidly connected to a conical flange cover 312 through screws, and the piston rod drives the conical flange cover 312 to perform a vibration in a horizontal direction. The force radiates to seawater through the conical flange cover 312 to generate a low-frequency high-energy seismic wave.

In a vibrating process of a marine vibration excitation system, a displacement sensor 316 mounted at a tail end of a piston rod 322 of the vibration exciter 310 and an acceleration sensor 317 and an attitude sensor 318 mounted on the conical flange cover 312 monitor a vibration state in real time, and feed information back to the electrohydraulic servo valve to better control a vibration frequency and an amplitude.

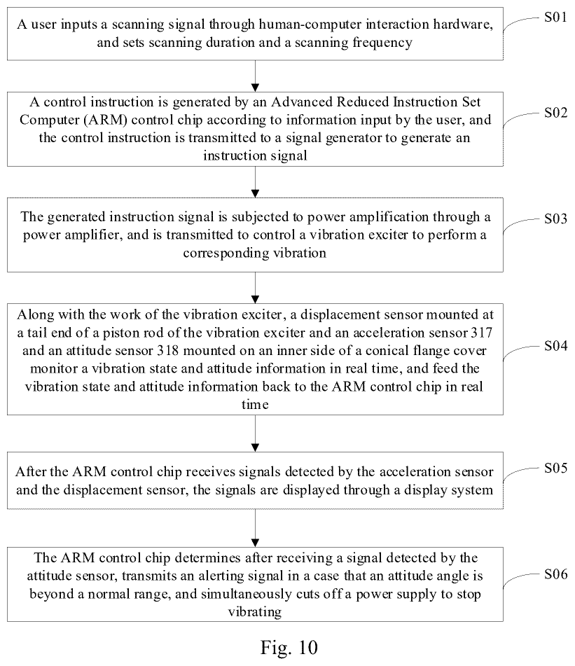

Referring to FIG. 9, a low-frequency hydraulic marine controllable seismic source system of the present application is also provided with a controller, which is connected to each of a signal excitation system 1, a hydraulic servo system 2, and a marine vibration excitation system 3. A control method of the system is as follows in FIG. 10.

At S01: A user inputs a scanning signal through human-computer interaction hardware, and sets scanning duration and a scanning frequency.

At S02: A control instruction is generated by an Advanced Reduced Instruction Set Computer (ARM) control chip according to information input by the user, and the control instruction is transmitted to a signal generator to generate an instruction signal.

At S03: The generated instruction signal is subjected to power amplification through a power amplifier, and is transmitted to control a vibration exciter to perform a corresponding vibration.

At S04: Along with the work of the vibration exciter, a displacement sensor mounted at a tail end of a piston rod of the vibration exciter and an acceleration sensor 317 and an attitude sensor 318 mounted on an inner side of a conical flange cover monitor a vibration state and attitude information in real time, and feed the vibration state and attitude information back to the ARM control chip in real time.

At S05: After the ARM control chip receives signals detected by the acceleration sensor and the displacement sensor, the signals are displayed through a display system.

At S06: The ARM control chip determines after receiving a signal detected by the attitude sensor, transmits an alerting signal in a case that an attitude angle is beyond a normal range, and simultaneously cuts off a power supply to stop vibrating.

It is to be noted that, terms “include” and “comprise” and any variations thereof in specification, claims and the above drawings of the present application are intended to cover non-exclusive inclusions. Terms “mount”, “arrange”, “provide with”, “connect” and the like are to be broadly understood. For example, the terms may refer to fixed connection, detachable connection, mechanical connection, or electrical connection, may refer to direct mutual connection, may also refer to indirect connection through a medium, and may refer to communication of interiors of two mechanisms, elements, or components. For those of ordinary skill in the art, specific meanings of the above terms in the present application can be understood according to specific conditions.

In the descriptions of the present application, it is to be understood that orientations or positional relationships indicated by terms “one end”, “the other end”, “one side”, “the other side”, “inner side”, “outer side”, “horizontal”, “tail end”, “left”, “right”, and the like are the orientations or positional relationships shown based on the accompanying drawings, and are merely for the convenience of describing the present application and simplifying the description, rather than indicating or implying that referred elements must have particular orientations, and constructed in particular orientations and thus are not to be understood as limitations to the present application. Terms “first” and “second” are merely used for the concision of description, rather than explicitly or implicitly indicating relative importance.

In addition, in practicing the claims of the present application, those skilled in the art can understand and influence changes in the disclosed embodiments through the study of the accompanying drawings, the disclosure, and the claims.

The above are only preferred embodiments of the present application and are not intended to limit an implementation scope of the present application. That is, all equivalent changes and modifications made according to the present application are covered in the claims of the present applications. Examples are not listed here one by one.

It is to be understood that above specific description about the present application is merely intended to describe the present application and is not limited to technical solutions described in embodiments of the present application. Those of ordinary skill in the art should understand that equivalent changes and modifications can still be made to the present application to achieve the same technical effects. Those are within the scope of protection of the present application as long as meeting use requirements.

What is claimed is:

1. A low-frequency hydraulic marine controllable seismic source system, comprising a signal excitation system, a hydraulic servo system, and a marine vibration excitation system, wherein
both the signal excitation system and the hydraulic servo system are arranged on a ship; the marine vibration excitation system is placed in seawater;
the hydraulic servo system comprises an electrohydraulic servo valve; an oil port of the electrohydraulic servo valve is communicated with an oil way; the marine vibration excitation system comprises a vibration exciter, a displacement sensor, an acceleration sensor, and an attitude sensor; a signal end of the electrohydraulic servo valve is connected to the signal excitation system; the signal end of the electrohydraulic servo valve is also connected to the displacement sensor, the acceleration sensor, and the attitude sensor;
the signal excitation system generates an excitation sweep signal, and transmits the excitation sweep signal to the electrohydraulic servo valve; after receiving the excitation sweep signal, the electrohydraulic servo valve controls an internal valve core of the electrohydraulic servo valve to generate a displacement to move continuously; after the electrohydraulic servo valve receives an input/output signal of a feedback rod, the feedback rod of the electrohydraulic servo valve outputs and applies a force of equal magnitude indicated by the input/output signal of the feedback rod to the vibration exciter to enable the vibration exciter to perform a vibration in a horizontal direction, and the force radiates to the seawater to generate a low-frequency high-energy seismic wave; and the displacement sensor, the acceleration sensor, and the attitude sensor mounted in the marine vibration excitation system monitor a vibration state, and feed information back to the electrohydraulic servo valve to control a vibration frequency and an amplitude.

2. The low-frequency hydraulic marine controllable seismic source system according to claim 1, wherein the hydraulic servo system comprises an oil tank, an oil outlet pipeline, and an oil return pipeline; the oil outlet pipeline comprises an oil suction filter, a plunger pump, a one-way valve, a high pressure filter, a high pressure accumulator, and an electromagnetic overflow valve; one end of the oil suction filter is connected to the oil tank, and the other end of the oil suction filter is connected to the high pressure filter through the plunger pump and the one-way valve; one end of the high pressure accumulator is connected to the high pressure filter, and the other end of the high pressure accumulator is connected to an oil outlet P; the high pressure accumulator is arranged to absorb a high frequency pulsation component at an outlet of the plunger pump to maintain a stable oil pressure; one end of the electromagnetic overflow valve is connected to the oil tank, and the other end of the electromagnetic overflow valve is connected to an oil way between the high pressure filter and the high pressure accumulator; the oil way between the high pressure filter and the high pressure accumulator is also connected to a seismic resistant pressure gauge through a pressure measuring joint and hose; the oil return pipeline comprises an overflow valve, a low pressure accumulator, and an oil return filter; one end of the oil return pipeline is connected to the oil tank, and the other end of the oil return pipeline is connected to an oil return port T through the overflow valve; an oil way between the overflow valve and the oil return port T is also connected to the low pressure accumulator to absorb an oil pressure of the oil return pipeline and eliminate oil discharge pressure fluctuations; and the low pressure accumulator is also connected to a pressure gauge.

3. The low-frequency hydraulic marine controllable seismic source system according to claim 2, wherein there is a flexible connection between the oil suction filter and the plunger pump; and a manual ball valve is arranged on a connecting pipeline between the oil suction filter and the flexible connection.

4. The low-frequency hydraulic marine controllable seismic source system according to claim 2, wherein an oil cooler is arranged on one side outside the oil tank to cool hydraulic oil; an air filter is mounted above a side, close to the oil cooler, in the oil tank; the air filter is arranged to filter air circulating in the oil tank; a liquid level gauge is also mounted on a side surface in the oil tank; and a metallic thermometer is also arranged on an inner wall of the oil tank to detect a temperature of the hydraulic oil.

5. The low-frequency hydraulic marine controllable seismic source system according to claim 1, wherein the marine vibration excitation system further comprises a housing, support discs, and conical flange covers; the housing is a cylindrical stainless steel housing; the vibration exciter is coaxially arranged in the housing through a fixing plate; the vibration exciter is a cylinder fixed double-rod piston vibration exciter; the support discs are arranged at two ends of the housing; two ends of an outer cylinder of the vibration exciter are respectively connected to the support discs; piston rods at two ends of the vibration exciter extend out of the support discs and are connected to the conical flange covers arranged on outer sides of the support discs; a rubber buffer ring is arranged between the housing and the conical flange cover; a top of the housing is provided with lifting lug seats, is provided with an oil inlet, an oil outlet, an air hole, and a wire hole, and is connected to the electrohydraulic servo valve through the oil inlet and the oil outlet; a data line is connected to the vibration exciter and the electrohydraulic servo valve through the wire hole; lifting lugs are arranged at tops of the two conical flange covers; a plurality of observation windows are formed in the housing on two sides of the lifting lug seats; a counterweight box is arranged at a bottom of the housing; the vibration exciter is connected to the hydraulic servo system through the oil inlet, the oil outlet, and the wire hole in the housing; and the air hole is externally connected to an air pump to realize underwater static pressure compensation.

6. The low-frequency hydraulic marine controllable seismic source system according to claim 5, wherein the fixing plate is a connecting plate with a circular hole in the centre; the circular hole of the fixing plate matches the piston rod; the vibration exciter penetrates through the circular hole of the fixing plate; and two ends of the fixing plate are connected to the housing.

7. The low-frequency hydraulic marine controllable seismic source system according to claim 5, wherein a centre hole that matches the piston rod is formed in a centre of the support disc; bolt holes that match a connecting flange on the outer cylinder of the vibration exciter are formed along a periphery of the centre hole; and a plurality of through holes are formed in a circumferential direction of the support disc to ensure a consistent working air pressure inside a cavity of the cylindrical stainless steel housing.

8. The low-frequency hydraulic marine controllable seismic source system according to claim 6, wherein a centre of the conical flange cover is connected to the piston rod at each of the two ends of the vibration exciter; and an edge of the conical flange cover is connected to the housing through the buffer ring.

9. The low-frequency hydraulic marine controllable seismic source system according to claim 5, wherein the displacement sensor of the marine vibration excitation system is mounted at a tail end of the piston rod; and the acceleration sensor and the attitude sensor are respectively mounted on inner sides of the conical flange covers at the two ends of the vibration exciter.

10. The low-frequency hydraulic marine controllable seismic source system according to claim 1, wherein a maximum vibration stroke of the vibration exciter is 300 millimetres.
